(19) United States
(12) Patent Application Publication
(10) Pub. No.: US 2005/0283446 A1
(43) Pub. Date: Dec. 22, 2005

(54) Fee models based on plug-in use

(75) Inventors: Richard D. Dettinger, Rochester, MN (US); Richard J. Stevens, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/870,375

(22) Filed: Jun. 17, 2004

(51) Int. Cl. G06F 17/60

(52) U.S. Cl. 705/400

(57) ABSTRACT

A method and apparatus for calculating fees charged to users based on the plug-in use is disclosed. An application framework is provided as an extensible software platform. Users may integrate plug-in components into the application framework. Each plug-in component may identify a fee model defining how charges are assessed for using the plug-in. An auditing component, calculates the fees charged to each user of the customized application framework based on the features of the application framework and the plug-in use made by each individual user.

### CROSS-REFERENCE TO RELATED APPLICATIONS

The present invention is related to the commonly owned, co-pending U.S. patent application Ser. No. 10/083,075, entitled “Application Portability and Extensibility through Database Schema and Query Abstraction,” filed Feb. 26, 2002, which is incorporated by reference in its entirety.

### BACKGROUND OF THE INVENTION

1. Field of the Invention

The present invention generally relates to a method of calculating the fees charged to the users of a software application, and more specifically, to a fee based model for calculating fees based on a user's feature and plug-in use of a software application.

2. Description of the Related Art

Information Technology (IT) encompasses all forms of technology used to create, store, exchange, and use information in its various forms (business data, voice conversations, still images, motion pictures, multimedia presentations, and other forms, including those not yet conceived). While information technology provides significant benefits to users, the providers of such technology often incur substantial costs. As such, it is common for providers to charge a fee for services rendered. For example, many service providers manage information databases and allow fee-based access to the databases. Such databases are particularly prevalent in various professions (e.g., medical, legal, and the like) as well as in research and development. Service providers in the information technology industry, however, are providing users with access to software applications in a networked environment using relatively inflexible and restrictive fee models.

Moreover, software applications have grown increasingly complex, distributed and modular. With this complexity, fewer applications are simply purchased, installed on a host computer and executed in a stand-alone capacity. Additionally, fewer computers lack a connection to a network, especially the Internet. The rapid growth of worldwide computer networks has precipitated the advent of networked software applications and online service providers.

Such service providers necessarily incur costs providing users with the capability to perform various tasks, including accessing and modifying stored data, and performing data processing, and conventional models exist for passing these costs on to the users. For example, some database providers charge a flat rate access fee, whereby paying users are provided access to selected resources. In other cases, service providers may charge fees depending on which resources are accessed. For example, users may be charged according to which databases are accessed. Typically, a periodic subscription fee is charged in addition to a la carte fees according to the resources accessed by the users. In addition to databases, service providers charge for other resources, such as CPU cycles and disk space consumed.

As service providers continue to cater to the growing complexity and specific needs of users by providing new functionality, accessibility and extensibility, new accounting approaches are needed to ensure that the value provided is reflected in the fees charged to users. In some cases, conventional fee models fail to adequately reflect the value of services that are provided. Consider, for example, a service provider that provides raw data to one user, but also provides a second user custom analysis package that may present a refinement of the data or recommendation or inferences drawn from the data. Consider further, a third user that develops its own data analysis plug-in to interpret the raw data that may be integrated into the system. Again, conventional fee models fail to reflect the differing value provided to these three users.

Accordingly, there is a need for improved methods and systems that will calculate the fees charged to the users of resources, based on the functionality and accessibility being offered to each user.

### SUMMARY OF THE INVENTION

The present invention is directed to methods, systems, and an article of manufacture for calculating fees charged to users of an application framework based on the actual plug-in components and features accessed or invoked by each user. Generally, an auditing component identifies a fee model corresponding to each plug-in component integrated with the application framework, and records a fee charged to a user for each fee triggering action that a user engages in while interacting with the application framework.

In one embodiment, the method generally includes the steps of integrating a set of plug-in components with the application framework and identifying at least one fee model corresponding to the plug-ins. Each fee model defines a set of fee triggering events and a corresponding fee amount. The method further includes the steps of monitoring the activity of users interacting with the application framework and set of plug-in components and calculating a fee based on the fee triggering events that occur during the use of the application framework and set of plug-in components.

In another embodiment, users of an application framework may selectively incur fees for using application framework accessible over a computer network by obtaining a plug-in component constructed according to a set of specifications that define an interface to the application framework and providing the plug-in components to a service provider hosting the application framework. Users accessing the application framework and plug-in component using a computer connected to the network and wile interacting with the application framework and plug-in component; and incur fees based on the fee triggering actions selected by the user.

Another embodiment provides a computer-readable medium containing an executable component for invoking an application framework and calculating fees charged to users of the application framework. When executed by a processor the executable component performs operations generally including invoking an application framework on a host computer connected to a computer network and integrating plug-in components provided to the application framework. Further, the executable component accepts connections requested by a user operating a remote computer connected to the computer network and monitors the activity that occurs while a user is connected to the application framework from the remote computer. The executable component calculates fees owed to the provider of the application framework based on the activity of the user.

One embodiment provides a system used to provide users an application framework and to calculate fees charged to different users of the application framework. The system generally includes a host computer running an application framework configured to integrate a collection of plug-in components and one or more resources accessible by the application framework. The system further provides an auditing component configured to monitor interaction between each user that makes a connection with the application framework and the set of plug-in components and to calculate a fee based upon each user's interactions with the of application framework and plug-in components.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

Note, however, that the appended drawings illustrate only typical embodiments of this invention and are therefore not to be considered limiting of its scope, for the invention may admit to other equally effective embodiments.

FIG. 1 is a computer system, according to one embodiment of the invention.

FIGS. 2A-2B are an illustrative relational view of software components, according to one embodiment of the invention.

FIG. 3 is an illustrative relational view of software components, according to one embodiment of the invention

FIG. 4 is a flow chart of method steps, according to one embodiment of the invention.

FIG. 5A is a relational view of software components, according to one embodiment of the present invention.

FIG. 5B illustrates an abstract query, according to one embodiment of the invention.

FIG. 6 illustrates a method exemplifying one embodiment of the operation of a runtime component.

FIG. 7 illustrates a method for processing an abstract query, according to one embodiment of the invention.

### DETAILED DESCRIPTION OF THE PREFERRED EMBODIMENTS

The present invention generally is directed to a system, method and article of manufacture for calculating the fees charged to different users of an application framework based on the plug-ins and features accessed by each user. Generally, users interact with an application framework that includes a set of features and integrated plug-ins customized for each user (or group of users). While doing so, an auditing component records each fee triggering event (or user initiated action) that occurs, such as, accessing a particular plug-in or performing a particular operation using a set of data made available along with the application framework. An auditing component monitors user activity and calculates a fee charged to users of the application framework.

In one embodiment, an application framework may be provided that allows additional, modules, plug-ins, extensions, hooks, API's, and the like, to be integrated into the application framework. Using these integrated components, different users of the application framework may augment, extend, or even re-define the functionality of the application framework according to their specific needs. Additionally, other parties may develop and distribute plug-ins that may be integrated into the application framework, and the provider of the application framework may provide additional plug-ins or other modular components to users.

In this application, reference is made to embodiments of the invention. It should be understood, however, that the invention is not limited to specific described embodiments. Instead, any combination of the following features and elements, whether related to different embodiments or not, is contemplated to implement and practice the invention. Furthermore, in various embodiments the invention may provide numerous advantages over the prior art. Although embodiments of the invention may achieve advantages over other possible solutions and/or over the prior art, however, whether or not a particular advantage is achieved by a given embodiment is not limiting of the invention. Thus, features, embodiments and advantages described herein are merely illustrative and are not considered elements or limitations of the appended claims except where explicitly recited in a claim(s). Similarly, reference to “the invention” shall neither be construed as a generalization of any inventive subject matter disclosed herein nor considered to be an element or limitation of the appended claims except where explicitly recited in a claim(s).

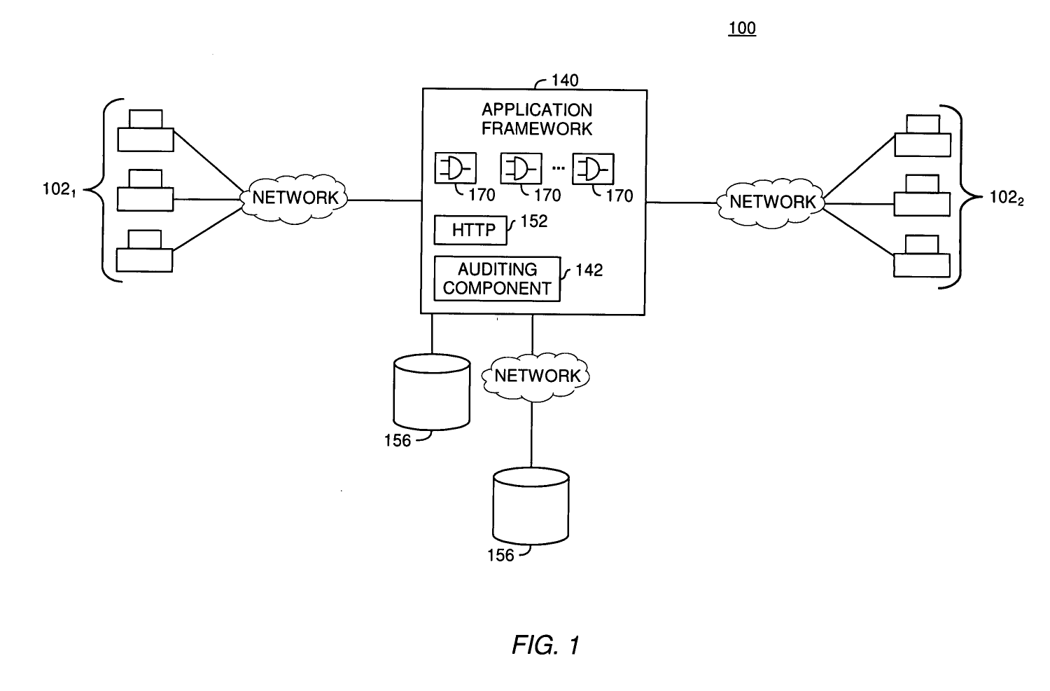

One embodiment of the invention is implemented as a program product for use with a computer system such as, for example, the enterprise system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media represent embodiments of the present invention when carrying computer-readable instructions that direct the functions of the present invention.

In general, the routines executed to implement the embodiments of the invention, may be part of an operating system or a specific application, component, program, module, object, or sequence of instructions. Software used to implant embodiments of the present invention is typically comprised of a multitude of instructions transformed into a machine-readable format, and hence, executable instructions. Software programs are also comprised of variables and data structures that may either reside locally to the program or may be found in memory or on storage devices. In addition, various programs described hereinafter may be identified based upon the application for which they are implemented in a specific embodiment of the invention. Those skilled in the art will appreciate, however, that any particular nomenclature that follows is used merely for convenience, and accordingly, does not limit the present invention to use solely in any specific application identified and/or implied by such nomenclature.

Embodiments of the present invention may be implemented in a hardware/software configuration including at least one networked client computer and at least one server computer, although the client-server model is merely illustrative, and not limiting of the invention. Furthermore, embodiments of the present invention apply to any comparable hardware configuration, regardless of whether the computer systems are complicated, multi-user computing apparatuses, single-user workstations, or network appliances lacking, or with limited, non-volatile storage of their own.

FIG. 1 illustrates an application framework 140 deployed within an enterprise network environment 100. The application framework 140 is configured with additional, modules, plug-ins, extensions, hooks, API's, and the like (collectively referred to as plug-in components or just plug-ins) that may be integrated into the application framework 140. Plug-in components 170_{1-N} comprise an additional software component configured to operate as part of the application framework. The application framework 140 and integrated plug-ins 170 may manipulate data stored in databases 156. In one embodiment, the databases reside locally with the same server computer hosting the application framework 140. Alternatively, or in addition, the application framework 140 may access databases located on other computers accessible over the network. In one embodiment described in greater detail below, users interact with the application framework 140 and databases 156 through a data abstraction model configured to separate the logical and substantive content of the databases 156 from a particular mechanism used to store the data.

Each plug-in 170 component may extend, alter, or operate alongside the functionality of application framework 140. For example, one plug-in component 170 might perform a complex statistical analysis on data retrieved from databases 156. In addition to providing a platform to execute plug-in components 170, the application framework 140 may provide users with its own features. For example, the application framework 140 may provide a query engine feature configured to retrieve and store data in databases 156. As the query engine processes queries, different plug-ins 170 (provided either by users or the service provider) may be configured to operate on query results. As used herein, a feature comprises a collection of related functions or operations provided by the application framework 140 that a user may incur a separate fee for accessing or invoking. Features may be part of the application framework 140 or may be a plug-in 170 provided by the service provider of the application framework 140.

In one embodiment, the application framework 140 includes an auditing component 142 that may be configured to record which features and plug-ins 170 are accessed by different users. The auditing component 142 may also record the number of times a user accesses or invokes a function of plug-in component 170. Each time such an event occurs (referred to herein as a fee triggering event) the auditing component 142 may record a fee amount charged to the user. Such a fee amount may be added to an account associated with the user. Alternatively, the auditing component may deduct the fee amount from a prepaid balance established to cover the cost of the services purchased by a user.

Each plug-in component 170 that is integrated into the application framework 140 may indicate a fee model corresponding to that plug-in 170. Generally, a fee model defines how the auditing component 142 should calculate charges for the use of a particular plug-in 170. Any conceivable fee model may be used for a given plug-in 170. For example, by associating the fees with a specific plug-in 170, conventional fee models may now be applied at the plug-in level. Accordingly, fee models may be based on the amount of disk storage required to house the plug-in 170 or on the number of CPU cycles used to perform a computational task or the amount of data processed by the plug-in.

In addition to applying these conventional models at the plug-in level, particular users may negotiate with a service provider and agree to a fee model to use with a particular plug-in 170. Thus, the fees assessed for use of the application framework 140 may be based on the unique value provided to a user based on the unique combination of the user's plug-in 170 with the application framework 140. Additional fee models may vary the charges assed to users depending on the individual user or a class of users. For example, different users might incur different fees for accessing the same collection of data via the same plug-ins. Doing so allows on-line service providers to include “preferred users” or charging user's a lesser fee based on their usage volume within the plug-in fee models.

However structured, each fee model indicates fee triggering events for which fees are charged along with a fee amount. Fee triggering events may include a user causing a plug-in to perform a particular function, consuming a certain amount of computational resources, accessing or invoking a feature of the application framework, and the like. For example, the service provider may provide access to a large data collection that a group of users wish to query and analyze using a custom plug-in 170. Such a plug-in may indicate a fee model that defines fees based on the number of records retrieved from databases 156, where another fee model may indicate to assess fees based on the number of computational resources consumed the plug-in 170 (e.g., the time required to execute a routine). Additionally, the auditing component 142 may assess fees for other fee triggering events such as a such as using a feature provided by the application framework 140, creating a new user account, or hosting and maintaining a plug-in 170 supplied by a user that is integrated with the application framework 140.

The auditing component 142 records the fee triggering events and fee amounts corresponding to each plug-in and feature accessed by a user of the application framework 140. Although the auditing component 142 is shown as a singular component external to the various plug-ins 170, it is also contemplated that the functionality of the auditing component 142 may be implemented by the individual plug-ins communicating with the application framework 140.

In one embodiment, users connect to the application framework using client computers 102. In general, each client computer 102 may comprise a general purpose computer workstation configured with hardware and software to communicate over a network and to establish a connection with the computer server hosting the application framework 140. Two such groups of users, 102₁ and 102₂, are illustratively shown. Any number of different groups of users may connect to the application framework, and each discrete group may use its own combination of plug-ins 170 with application framework 140. Within each discrete group, individual users may incur different charges based upon the particular plug-ins 170 and features of the application framework 140 accessed by that user.

In one embodiment, users interact with the application framework 140 through a graphical user interface (GUI), such as a client program running on each client computer 102. The content of the GUIs may be generated by the application framework(s) 140. In a particular embodiment, the client program is a web browser and the GUI content is hypertext markup language (HTML) content which may be rendered on the client computer systems 102. Accordingly the application server 140 illustratively includes a Hypertext Transfer Protocol (http) server 152 (e.g., a web server) adapted to service requests from the client computer 102.

FIG. 1 is merely one hardware/software configuration for the networked client computer 102 and server computer 104. Embodiments of the present invention can apply to any comparable hardware configuration, regardless of whether the computer systems are complicated, multi-user computing apparatus, a cluster of individual computers connected by high speed network channels and configured to act as a single unit, single-user workstations, or network appliances that do not have non-volatile storage of their own. Further, it is understood that while reference is made to particular markup languages, including HTML, the invention is not limited to a particular language, standard or version. Accordingly, persons skilled in the art will recognize that the invention is adaptable to other markup languages as well as non-markup languages and that the invention is also adaptable future changes in a particular markup language as well as to other languages presently unknown. Likewise, the http server 152 shown in FIG. 1 is merely illustrative and other embodiments may be configured to communicate over a network using other known and unknown protocols.

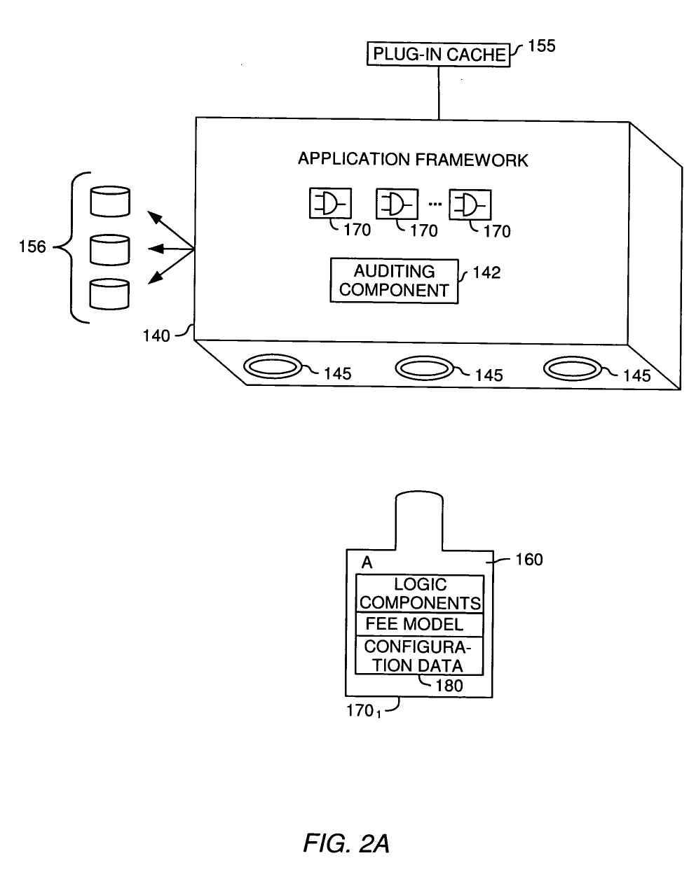

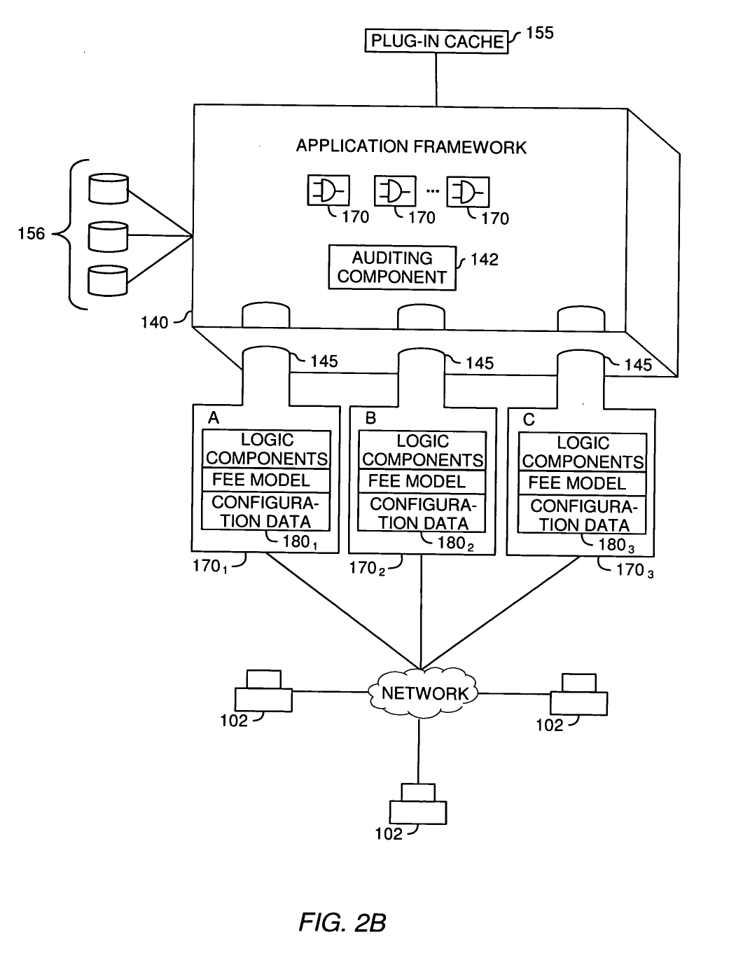

FIG. 2A illustrates a relational view of components of the application framework 140 and plug-ins 170. As illustrated, the application framework 140 includes an auditing component 142, plug-in components 170, and plug-in connection points 145. As described above, application framework 140 provides a common framework for plug-in components 170. Within this common framework, plug-ins 170 serve to extend, modify, enhance, or replace the functionality of application framework 140. Plug-in points 145 provide an interface for additional plug-in components 170 to integrate with the application framework 140.

In one embodiment, the connection points 145 specify a connection location to the application framework residing in a networked environment. For example, an internet protocol (IP) address and port number may be used to specify a connection point 145 for a user to establish a connection with the application framework 140 and to transfer plug-ins 170 to the application framework 140. In addition, a connection point 145 may be specified not just quantitatively by a physical network address, but also qualitatively by an application framework specification describing the application framework 140 and how users may construct plug-in components 170 that may be integrated into the application framework 140. Such a specification may also describe the auditing component 142, and the permitted types of fee models that a plug-in 170 may provide to the application framework 140.

In one embodiment, application framework 140 also manages security and access authorizations associated with remote users. Access authorizations may define which plug-ins 170 a group of users, or individuals within a group of users, are authorized to access and to incur charges for using. Accordingly, a user may be required to log on to the application framework 140 using a username and password combination. Once authenticated, the application framework 140 may display the application framework 140 and integrated plug-in components 170 appropriate to that user. Additionally, the application framework 140 may be configured to execute any plug-ins 170 provided by a user within a “secure sandbox” to prevent, or at least limit, malicious or “buggy” plug-ins from harming the server computer hosting the application framework 140. As those skilled in the art will understand, a “secure sandbox” provides a secure operating environment configured to execute un-trusted plug-ins that provides each plug-in with a limited set of resources and also monitors the actions of each un-trusted plug-in to prevent any prohibited actions.

As illustrated in FIG. 2A, in one embodiment, plug-in 170 may include logic components (i.e., the application logic of the plug-in), a fee model, and configuration data 180. Each plug-in 170 allows a group of one or more common users to access and interact with the application framework 140 in a customized fashion. The configuration data 180 may identify what plug-ins the application framework 140 should make available to a user, including any user supplied plug-ins. The logic components implement the functionality of a plug-in 170 supplied by a user. The logic component may comprise a single function or many discrete logic components used to complete complex computational tasks. In some embodiments, the logic components may implement proprietary search methods or data analysis techniques developed by (or licensed to) a particular group of users (e.g., user group 102₁ or 102₂ illustrated in FIG. 1.) Each plug-in 170 may indicate the fee model associated with the plug in to the auditing component 142. As described above, a fee model defines how fees are calculated for the use of a particular plug-in 170 and what fee triggering events are associated with the plug-in 170.

In one embodiment, the application framework 140 maintains a copy of plug-ins supplied by a user in plug-in cache 155 to reduce the amount of information that must be transferred across the network each time a user connects to the application framework. While users interact with the application framework 140, the auditing component 142 records fee triggering events and calculates fee amounts incurred by a particular user based on the use of plug-in 170.

The plug-ins 170, integrated with the application framework 140, work to manipulate (i.e., search, select, retrieve, modify, add, and analyze) data stored in databases 156. Together they provide new functionality unavailable solely through the use of the application framework 140, and the fee model may capture the value created by this unique combination. In one embodiment, plug-ins 170 may be supplied to the provider of an application framework 140 and stored in databases 156. When a user running a client program on computer 102 connects to the application framework 140, configuration data 180 is used to retrieve the plug-ins 170 appropriate for that user. (e.g., one of the client computers 102₁ and 102₂ illustrated in FIG. 1.) In an alternative embodiment, plug-ins 170 may be stored on client computers 102 and transmitted to the application framework 140 across the network each time a user connects to the system.

FIG. 2B illustrates a set of plug-ins 170₁₋₃ integrated with the application framework 140. As shown, plug-ins 170₁₋₃ are connected to the application framework 140 via plug in points 145 illustrated in FIG. 2A. Due to different user configuration data 180, different users are presented with a different collection of feature sets and plug-ins provided by the service provider. While a user interacts with the application framework 140, the auditing component 142 records fee triggering events that occur according to the fee model associated with each discrete plug-in 170. Additionally, the auditing component may record which features or plug-ins 170 supplied by the service provider of the application framework 140 are accessed or invoked by users. As fee triggering events occur, the auditing component 140 records the fee amount for the use of the plug-170 against an account associated with the user.

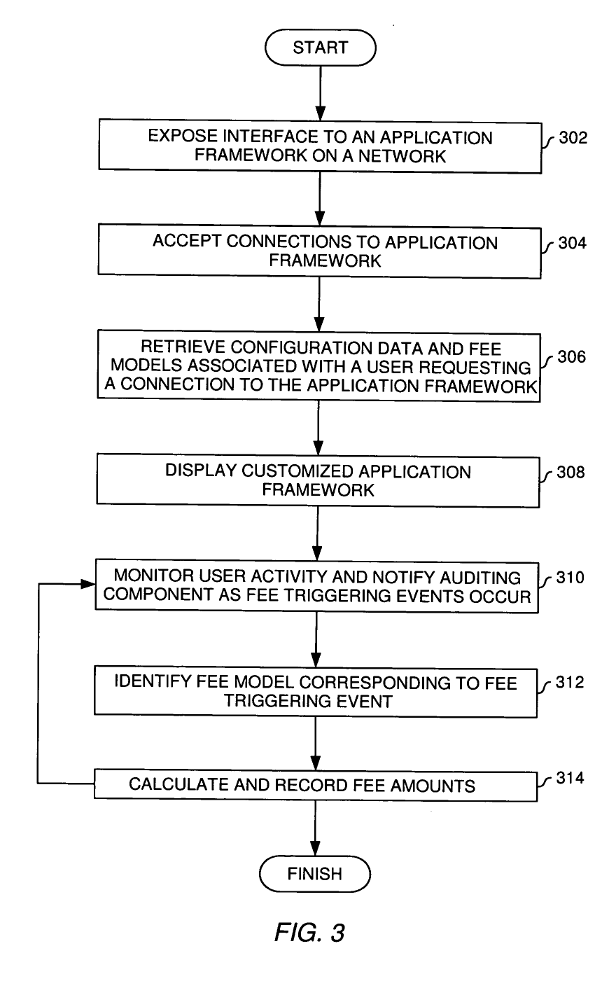

FIG. 3 is a flow chart that illustrates method steps for calculating fees based on plug-in use within an application framework 140, according to one embodiment of the invention. Operations 300 begin at step 302 when application framework 140 exposes an interface to the application framework in a network environment. Different users may connect to the application framework and interact with the features and plug-ins provided by the application framework. Additionally, the interface includes a means for users to supply additional plug-ins 170 and integrate them with the application framework 140.

In step 304, the application framework 140 accepts a connection from a user operating a client program on computer 102. In one embodiment, before accepting a connection to the application framework 140, users must supply a username and password. Once connected, the configuration data 180 corresponding to the user indicates which plug-ins 170 and feature sets should be made available to the user. Although the configuration data 180 is shown as a component within each individual plug-in 170, it is also contemplated that the configuration data may be stored within the application framework 140. In one embodiment, the application framework 140 maintains an index of configuration data 180 corresponding to users of the system. In step 306, the application framework 140 identifies the fee model corresponding to the logic components included in a plug-in 170 supplied to the application framework 140 by a user 102 connecting to the system. Additionally, the configuration data 180 may incorporate which fee models correspond to the features or other functionality provided by the application framework to the user. Thus, different users may be charged different amounts, or employ a different fee model used to calculate charges for accessing the same plug-ins This allows a service provider to calculate fee amounts for plug-in use based on both the nature of the services being provided, and the price sensitivity of a particular user group.

After retrieving the configuration data 180, at step 308 the application framework 140 and set of integrated plug-ins 170 are displayed to the user. At this point, the application framework is 140 ready to process user activity. In one embodiment, the application framework 140 is displayed through a web-based interface using a client program 122 such as a web browser. In an alternative embodiment, users may develop a custom application to display the application framework 140. Once connected, the user interacts with the application framework 140 using the customized collection of feature sets and plug-ins 170, some of which may be supplied by the user as described above. While doing so, at step 310, the application framework 140 monitors the activity of the user and signals the auditing component 142 as fee triggering events occur. In step 312, the auditing component identifies the fee model corresponding to based on the activity (and optionally the identity) of an individual user. For example, a custom analysis plug-in 170 supplied by a user might operate on data retrieved from databases 156. The corresponding fee model might be tied to the number of rows retrieved by each search performed by a user. Thus, as larger search results are used by the custom plug-in 170, the fee amount increases accordingly. The monitoring process continues until a user completes a session. Finally, at step 314 the auditing component calculates the fee corresponding to each fee triggering event using the fee model and any associated information, e.g., the number of rows returned by a search, the identity of a user, or other metrics associated with a fee triggering event.

Using operations 300, application framework 140 and auditing component 142 calculate fees with greater precision than a model that charges for use of the overall service or fees based on computational resources consumed. Accordingly, as different users interact with the same application framework, 140 different fee charges are calculated according to each user's path through the system.

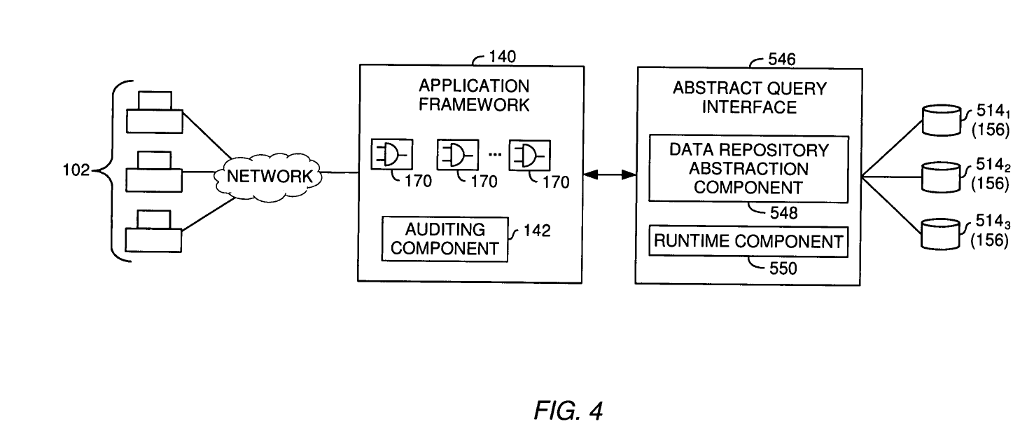

FIG. 4 illustrates one embodiment of the invention wherein the application framework 140 is includes access to 104 query interface that is used to construct an abstract query composed of a collection of logical fields.

Abstract Queries

An abstract query is composed using logical fields defined by a data abstraction model. Each logical field is mapped to one or more physical entities of data of an underlying data representation being used in databases 156 (e.g., XML, SQL, or other type representation). Furthermore, in the data abstraction model the logical fields are defined independently from the underlying data representation, thereby allowing queries to be formed that are loosely coupled to the underlying data representation. The abstract query can be configured to access the data and return query results, or to modify (i.e., insert, delete or update) the data. For execution against the database 156, the abstract query is transformed into a form (referred to herein as a concrete query) consistent with the underlying data representation of the data 156. Abstract queries and transformation of abstract queries into concrete queries is described in detail in the commonly owned, co-pending U.S. patent application Ser. No. 10/083,075, entitled “Application Portability And Extensibility Through Database Schema And Query Abstraction,” filed Feb. 26, 2002, which is incorporated by reference in its entirety.

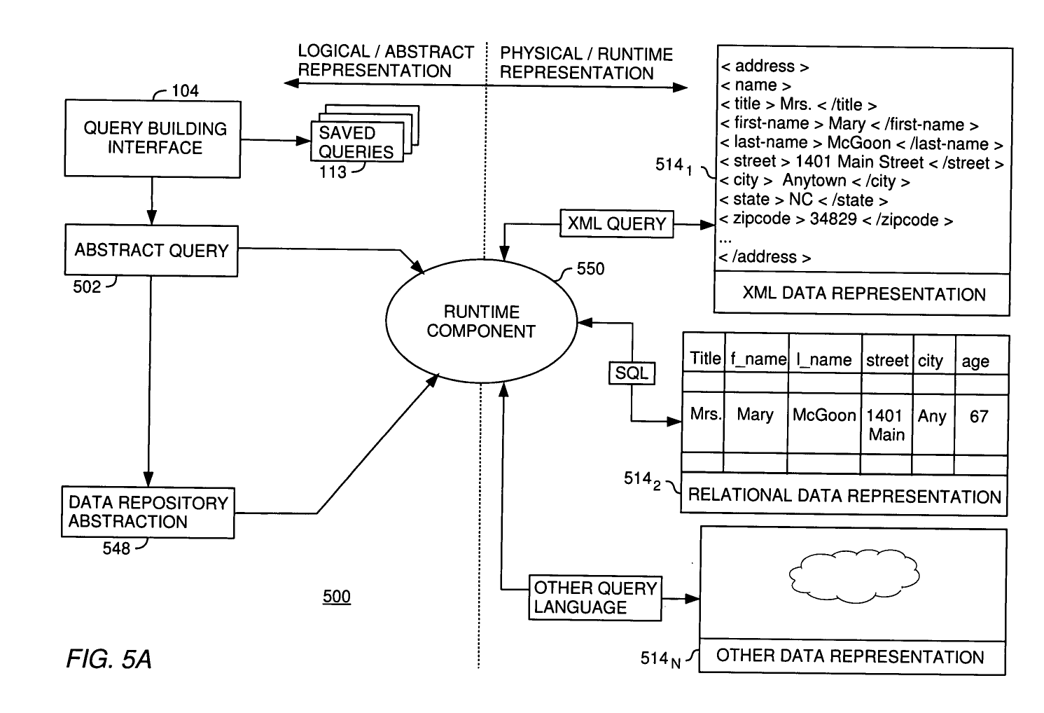

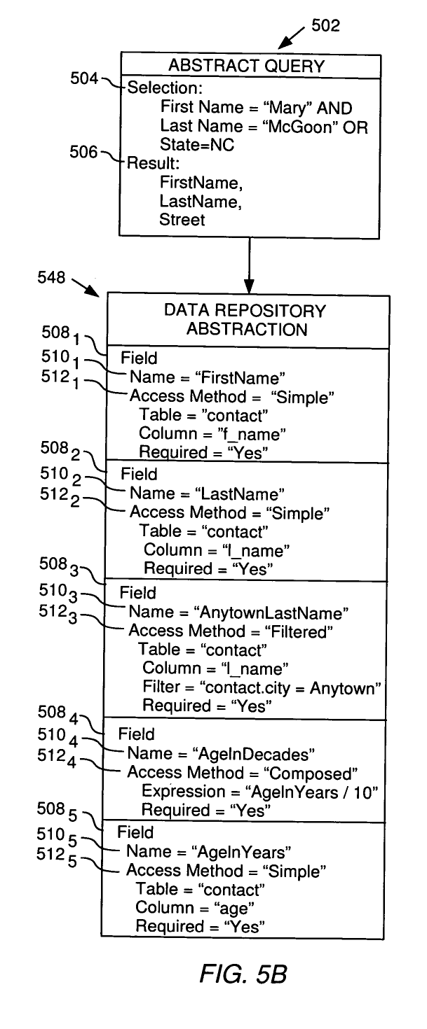

Details of one embodiment in which abstract queries are used are now described with respect to FIGS. 5-8.

FIGS. 5A-B show a plurality of interrelated components cooperating for the composition, issuance and transformation of abstract queries. The query building interface 104 issues an abstract query 502 which may be have been composed by a user during a current session or may be one of a saved queries 113 from a prior session. The issued query 502 is referred to herein as an “abstract query” because the query is composed according to abstract (i.e., logical) fields rather than by direct reference to the underlying physical data entities in the database 514_{1-N}. As a result, abstract queries may be defined that are independent of the particular underlying data representation used. In one embodiment, the query 502 may include both criteria used for data selection (selection criteria 504) and an explicit specification of the fields to be returned (return data specification 506) based on the selection criteria 504 (shown in FIG. 5B).

The logical fields used to compose the abstract query 502 are defined by a data repository abstraction component 548. In general, the data repository abstraction component 548 exposes information as a set of logical fields that may be used within a query (e.g., the abstract query 502) to specify criteria (i.e., the criteria 504) for data selection and specify the form of result data returned from a query operation (i.e., the return data specification 506). The logical fields are defined independently of the underlying data representation being used in the database 514, thereby allowing queries to be formed that are loosely coupled to the underlying data representation.

In general, the data repository abstraction component 548 comprises a plurality of field specifications 508₁, 508₂, 508₃, 508₄ and 508₅ (five shown by way of example), collectively referred to as the field specifications 508. Specifically, a field specification is provided for each logical field available for composition of an abstract query. Each field specification comprises a logical field name 510₁, 510₂, 510₃, 510₄, 510₅ (collectively, field name 510) and an associated access method 512₁, 512₂, 512₃, 512₄, 512₅ (collectively, access method 512). The access methods associate (i.e., map) the logical field names to a particular physical data representation 514₁, 514₂ . . . 514_{N} in a database (e.g., the databases 156). By way of illustration, two data representations are shown, an XML data representation 514₁ and a relational data representation 514₂. However, the physical data representation 514_{N} indicates that any other data representation, known or unknown, is contemplated.

Any number of access methods are contemplated depending upon the number of different types of logical fields to be supported. In one embodiment, access methods for simple fields, filtered fields and composed fields are provided. The field specifications 508₁, 508₂ and 508₅ exemplify simple field access methods 512₁, 512₂, and 512₅, respectively. Simple fields are mapped directly to a particular entity in the underlying physical data representation (e.g., a field mapped to a given database table and column). By way of illustration, the simple field access method 512₁ shown in FIG. 5B maps the logical field name 510₁ (“FirstName”) to a column named “f_name” in a table named “contact”. The field specification 508₃ exemplifies a filtered field access method 512₃. Filtered fields identify an associated physical entity and provide rules used to define a particular subset of items within the physical data representation. An example is provided in FIG. 5B in which the filtered field access method 512₃ maps the logical field name 510₃ (“AnytownLastName”) to a physical entity in a column named “I_name” in a table named “contact” and defines a filter for individuals in the city of Anytown. Another example of a filtered field is a New York ZIP code field that maps to the physical representation of ZIP codes and restricts the data only to those ZIP codes defined for the state of New York. The field specification 508₄ exemplifies a composed field access method 512₄. Composed access methods compute a logical field from one or more physical fields using an expression supplied as part of the access method definition. In this way, information which does not exist in the underlying data representation may be computed. In the example illustrated in FIG. 5B the composed field access method 512₃ maps the logical field name 510₃ “AgeInDecades” to “AgeInYears/10”. Another example is a sales tax field that is composed by multiplying a sales price field by a sales tax rate.

Note, however, that the data repository abstraction component 548 shown in FIG. 5B is merely illustrative of selected logical field specifications and is not intended to be comprehensive. As such, the abstract query 502 shown in FIG. 5B includes some logical fields for which specifications are not shown in the data repository abstraction component 548, such as “State” and “Street”.

It is contemplated that the formats for any given data type (e.g., dates, decimal numbers, etc.) of the underlying data may vary. Accordingly, in one embodiment, the field specifications 508 include a type attribute which reflects the format of the underlying data. However, in another embodiment, the data format of the field specifications 508 is different from the associated underlying physical data, in which case an access method is responsible for returning data in the proper format assumed by the requesting entity. Thus, the access method must know what format of data is assumed (i.e., according to the logical field) as well as the actual format of the underlying physical data. The access method can then convert the underlying physical data into the format of the logical field.

By way of example, the field specifications 508 of the data repository abstraction component 548 shown in FIG. 5A are representative of logical fields mapped to data represented in the relational data representation 514₂. However, other instances of the data repository abstraction component 548 map logical fields to other physical data representations, such as XML. Further, in one embodiment, a data repository abstraction component 548 is configured with access methods for procedural data representations.

An illustrative abstract query corresponding to the abstract query 502 shown in FIG. 5 is shown in Table I below. By way of illustration, the data repository abstraction 548 is defined using XML. However, any other language may be used to advantage.

TABLE I
QUERY EXAMPLE

| | |
|---|---|
| 001 | <?xml version=“1.0”?> |
| 002 | <?--Query string representation: (FirstName = “Mary” |
| 003 | AND LastName = “McGoon”) OR State = “NC”--> |
| 004 | <QueryAbstraction> |

| | |
|---|---|
| 005 | <Selection> |

| | |
|---|---|
| 006 | <Condition internalID=“4”> |

| | |
|---|---|
| 007 | <Condition field=“FirstName” operator=“EQ” |

| | |
|---|---|
| 008 | value=“Mary” internalID=“1”/> |

| | |
|---|---|
| 009 | <Condition field=“LastName” operator=“EQ” |

| | |
|---|---|
| 010 | value=“McGoon” internalID=“3” relOperator= |
| | “AND”></Condition> |

| | |
|---|---|
| 011 | </Condition> |
| 012 | <Condition field=“State” operator=“EQ” |

| | |
|---|---|
| 013 | value=“NC” internalID=“2” relQperator=“ |
| | OR”></Condition> |

| | |
|---|---|
| 014 | </Selection> |
| 015 | <Results> |

| | |
|---|---|
| 016 | <Field name=“FirstName”/> |
| 017 | <Field name=“LastName”/> |
| 018 | <Field name=“Street”/> |

| | |
|---|---|
| 019 | </Results> |

| | |
|---|---|
| 020 | </QueryAbstraction> |

Illustratively, the abstract query shown in Table I includes a selection specification (lines 005-014) containing selection criteria and a results specification (lines 015-019). In one embodiment, a selection criterion consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria.

An illustrative instance of a data repository abstraction component 548 corresponding to the abstract query in Table I is shown in Table II below. By way of illustration, the data repository abstraction component 548 is defined using XML. However, any other language may be used to advantage.

TABLE II
DATA REPOSITORY ABSTRACTION EXAMPLE

| | |
|---|---|
| 001 | <?xml version=“1.0”?> |
| 002 | <DataRepository> |

| | |
|---|---|
| 003 | <Category name=“Demographic”> |

| | |
|---|---|
| 004 | <Field queryable=“Yes” name=“FirstName” |
| | displayable=“Yes”> |

| | |
|---|---|
| 005 | <AccessMethod> |

| | |
|---|---|
| 006 | <Simple columnName=“f_name” |
| | tableName=“contact”></Simple> |

| | |
|---|---|
| 007 | </AccessMethod> |
| 008 | <Type baseType=“char”></Type> |

| | |
|---|---|
| 009 | </Field> |
| 010 | <Field queryable=“Yes” name=“LastName” |
| | displayable=“Yes”> |

| | |
|---|---|
| 011 | <AccessMethod> |

| | |
|---|---|
| 012 | <Simple columnName=“I_name” |
| | tableName=“contact”></Simple> |

| | |
|---|---|
| 013 | </AccessMethod> |
| 014 | <Type baseType=“char”></Type> |

| | |
|---|---|
| 015 | </Field> |
| 016 | <Field queryable=“Yes” name=“State” |
| | displayable=“Yes”> |

| | |
|---|---|
| 017 | <AccessMethod> |

| | |
|---|---|
| 018 | <Simple columnName=“state” tableName= |
| | “contact”></Simple> |

| | |
|---|---|
| 019 | </AccessMethod> |
| 020 | <Type baseType=“char”></Type> |

| | |
|---|---|
| 021 | </Field> |

| | |
|---|---|
| 022 | </Category> |

| | |
|---|---|
| 023 | </DataRepository> |

Note that lines 004-009 correspond to the first field specification 508₁ of the Data repository abstraction component 548 shown in FIG. 5B and lines 010-015 correspond to the second field specification 508₂. For brevity, the other field specifications defined in Table I have not been shown in FIG. 5B. Note also that Table I illustrates a category, in this case “Demographic”. A category is a grouping of one or more logical fields. In the present example, “First Name”, “Last Name” and “State” are logical fields belonging to the common category, “Demographic”.

Abstract queries are transformed into concrete queries, by a runtime component 550, and then executed. The transformation of abstract queries into concrete queries is described in detail below.

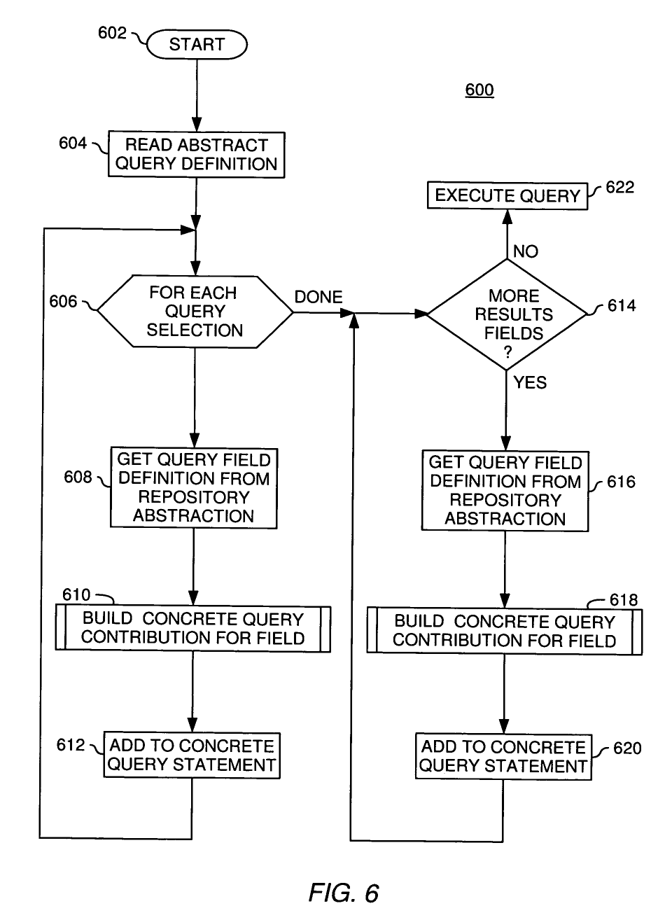

FIG. 6 shows an illustrative runtime method 600 exemplifying one embodiment of the operation of the runtime component 550. The method 600 is entered at step 602 when the runtime component 550 receives as input an instance of an abstract query (such as the abstract query 502 shown in FIG. 5B). At step 604, the runtime component 550 reads and parses the instance of the abstract query and locates individual selection criteria and desired result fields. At step 606, the runtime component 550 enters a loop (comprising steps 606, 608, 610 and 612) for processing each query selection criteria statement present in the abstract query, thereby building a data selection portion of a Concrete Query. In one embodiment, a selection criterion consists of a field name (for a logical field), a comparison operator (=, >, <, etc) and a value expression (what is the field being compared to). At step 608, the runtime component 550 uses the field name from a selection criterion of the abstract query to look up the definition of the field in the data repository abstraction 548. As noted above, the field definition includes a definition of the access method used to access the physical data associated with the field. The runtime component 550 then builds (step 610) a Concrete Query Contribution for the logical field being processed. As defined herein, a Concrete Query Contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the databases 156 shown in FIG. 1. The Concrete Query Contribution generated for the current field is then added to a Concrete Query Statement. The method 600 then returns to step 606 to begin processing for the next field of the abstract query. Accordingly, the process entered at step 606 is iterated for each data selection field in the abstract query, thereby contributing additional content to the eventual query to be performed.

After building the data selection portion of the concrete query, the runtime component 550 identifies the information to be returned as a result of query execution. As described above, in one embodiment, the abstract query defines a list of abstract fields that are to be returned as a result of query execution, referred to herein as a result specification. A result specification in the abstract query may consist of a field name and sort criteria. Accordingly, the method 600 enters a loop at step 614 (defined by steps 614, 616, 618 and 620) to add result field definitions to the concrete query being generated. At step 616, the runtime component 550 looks up a result field name (from the result specification of the abstract query) in the data repository abstraction 548 and then retrieves a Result Field Definition from the data repository abstraction 48 to identify the physical location of data to be returned for the current logical result field. The runtime component 550 then builds (as step 618) a Concrete Query Contribution (of the concrete query that identifies physical location of data to be returned) for the logical result field. At step 620, Concrete Query Contribution is then added to the Concrete Query Statement. Once each of the result specifications in the abstract query has been processed, the query is executed at step 622.

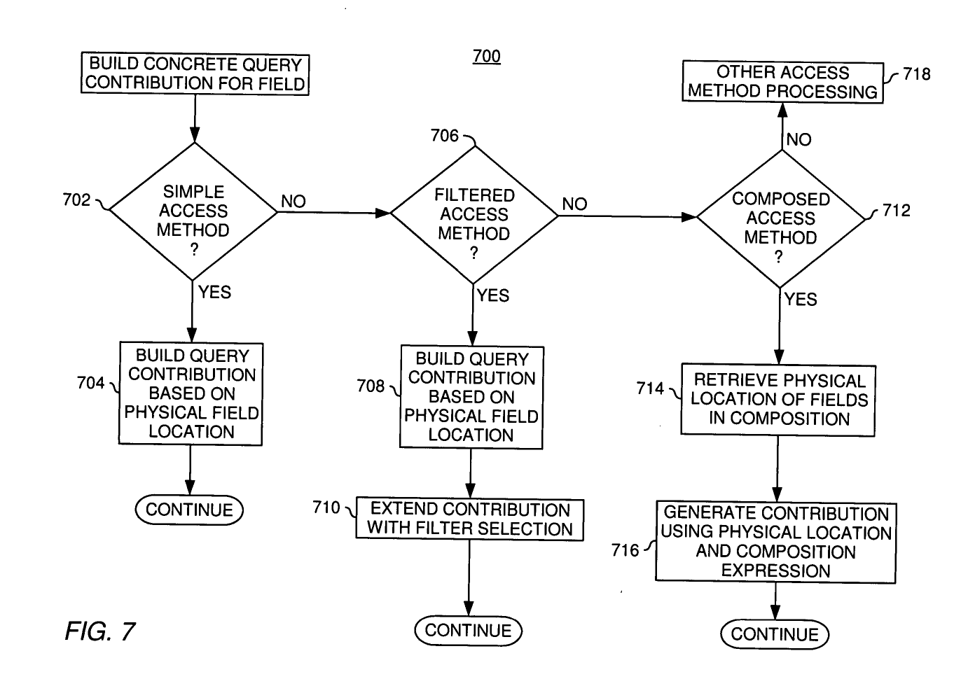

One embodiment of a method 700 for building a Concrete Query Contribution for a logical field according to steps 610 and 618 is described with reference to FIG. 7. At step 702, the method 700 queries whether the access method associated with the current logical field is a simple access method. If so, the Concrete Query Contribution is built (step 704) based on physical data location information and processing then continues according to method 600 described above. Otherwise, processing continues to step 706 to query whether the access method associated with the current logical field is a filtered access method. If so, the Concrete Query Contribution is built (step 708) based on physical data location information for some physical data entity. At step 710, the Concrete Query Contribution is extended with additional logic (filter selection) used to subset data associated with the physical data entity. Processing then continues according to method 600 described above.

If the access method is not a filtered access method, processing proceeds from step 706 to step 712 where the method 700 queries whether the access method is a composed access method. If the access method is a composed access method, the physical data location for each sub-field reference in the composed field expression is located and retrieved at step 714. At step 716, the physical field location information of the composed field expression is substituted for the logical field references of the composed field expression, whereby the Concrete Query Contribution is generated. Processing then continues according to method 600 described above.

If the access method is not a composed access method, processing proceeds from step 712 to step 718. Step 718 is representative of any other access methods types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

As described above, it may be necessary to perform a data conversion if a logical field specifies a data format different from the underlying physical data. In one embodiment, an initial conversion is performed for each respective access method when building a Concrete Query Contribution for a logical field according to the method 700. For example, the conversion may be performed as part of, or immediately following, the steps 704, 708 and 716. A subsequent conversion from the format of the physical data to the format of the logical field is performed after the query is executed at step 622. Of course, if the format of the logical field definition is the same as the underlying physical data, no conversion is necessary.

Returning to FIG. 4, which illustrates an application framework 140 operatively coupled with an abstract query interface 546. As described above, the abstract query interface 546 allows users 102 to compose query a set of databases independently of the representation mechanisms used to store data. Although illustrated as separate components, it is contemplated that the abstract query interface 546 and the application framework 140 may be integrated as a single software program. In one embodiment, the fields 508 included in a data repository abstraction component 548 indicate a fee model associated with some of the fields 508. Illustratively, the plug-in components 170 may provide users the ability to construct complex abstract queries 502. In such an embodiment, the run time component 550 may then execute such queries and retrieve selected data from the data repositories 514. Additional plug-ins 170 supplied by the user may then interpret the returned results by performing an analysis on the returned data and formatting the results for display by the client application 122. At the same time, the auditing component 142 records the fee triggering events that occur, including, for example, generating the abstract query, processing the abstract query, and invoking logic components the custom plug in-170 to perform an analysis on the results.

Using the techniques described herein, a number of illustrative examples of fee based models based on plug-in use may be described.

In one illustrative embodiment, databases 156, may store life-sciences data. For example, the databases 156 might store genetic information such as DNA sequences, gene sequences, and even entire genomes. Another life-science example includes storing demographic and medical information related to patient treatment and outcomes. A service provider may construct an application framework 140 configured to allow users to access the life-sciences data. Users may construct custom plug-ins 170 that analyze or interpret search results to detect interesting DNA sequences (e.g. coding regions) within a genome. Other plug-ins 170 may provide users with a mechanism to compose a complex abstract query and analyze result information to detect latent patterns related to drug interactions. By selecting the appropriate search criteria, researches could create virtual patient studies from the underlying data. This information could be the basis of further research or could also be used in commercial settings, for example, to predict statistical probabilities used to calculate health and life insurance rates.

In such an embodiment, the service provider hosting the application framework 140 may tailor fee models used to calculate the fees charged to a user in any number of ways. A fee, for example, might be based on the amount of information returned in response to particular search queries. Alternatively, fee models could be based on the availability of the data from another source (e.g., the cost to the user of a custom analysis plug-in 170 to create comparable data sources or to obtain the similar data from other providers). A fee model may also provide for charges for each use of a specific plug-in 170, for running queries on particular subsets of data stored in the databases 156, or for the discrete use of other features provided by the application framework 140. Using the fee model associated with each of these events, the auditing component 142 calculates and records the fees amounts incurred by each user interacting with the application framework 140.

In another illustrative embodiment, the databases 156 may store information related to credit history and commercial transactions of an individual or commercial entity. An application framework 140 might configured to integrate customized access for users to selectively mine information from the databases 156 using proprietary data mining techniques. Generally, any data collection maintained by one party might be the target of an application framework 140 used to integrate custom plug-ins 170 that other parties develop to query and analyze the data collection.

Embodiments of the invention allow a user more control over the costs incurred for accessing information technology resources and also allow a service provider to broaden the revenue sources associated with a software application. In one embodiment, the application framework 140 may provide a user with an on-screen display that indicates to a user the current costs that have been incurred (or an account balance that remains) based on use of an application framework 140 and integrated plug in components 170. For example, a taskbar of a given operating system may display a meter reflecting the real-time fees incurred by a user of the application framework 140.

In one embodiment, additional fee models are provided to define the fees a user will incur for accessing the discrete features provided by the application framework 140 and services provided by the service provider. For example, fee models may define fees for the use of a plug-in 170 provided by the service provider, for hosting plug-ins 170 supplied to the service provider, and for accessing individual features made available with the application framework 140.

While the foregoing is directed to embodiments of the present invention, other and further embodiments of the invention may be devised without departing from the basic scope thereof, and the scope thereof is determined by the claims that follow.

1. A method of calculating fees charged to users of an application framework, comprising:
integrating a set of plug-in components with the application framework;
identifying at least one fee model associated with the set of plug-ins wherein each fee model defines a set of fee triggering events and a corresponding fee amount;
monitoring the use of the set of plug-ins and the application framework; and
calculating a fee based on the fee triggering events that occur during the use of the application framework and set of plug-in components.

2. The method of claim 1, further comprising exposing an interface to the application framework on a computer network and accepting connection requests to the application framework.

3. The method of claim, 2, further comprising displaying to the user an indication of fees that the user has incurred while interacting with the application framework and set of plug-in components.

4. The method of claim 2, wherein accepting connection requests to the application framework, comprises receiving configuration data from a user, wherein the configuration data comprises information used by the application framework to identify the user.

5. The method of claim 4, wherein at least one fee model associated with the set of plug-ins is based on the identity of the user requesting to connect to the application framework.

6. The method of claim 4, wherein the configuration data is retrieved from a database maintained by the provider of the application framework based on the identity of the user making of the connection request.

7. The method of claim 4, wherein at lest one plug-in component integrated with the application framework is selected based on the identity of the user making the connection request.

8. The method of claim 4, wherein the set of plug-in components includes at least one plug-in component supplied by the user making the connection request.

9. The method of claim 8, wherein the at least one plug-in component operates within a limited computing environment provided by the application framework to the plug-in component to prevent the plug-in component from performing any prohibited actions.

10. The method of claim 8, wherein the application server maintains a copy of the at least one plug-in component provided by a user establishing a connection with the application framework.

11. The method of claim 2, wherein fee triggering events comprise at least one of consuming a defined amount of resources, invoking a function provided by a plug-in component or a feature of the application framework, and supplying a plug-in component to the application framework.

12. The method of claim 2, wherein calculating a fee comprises calculating the sum of each fee amount corresponding to each fee triggering event that occurs while a user is connected to the application framework and plug-in components.

13. The method of claim 2, wherein exposing an interface to the application framework comprises exposing a web-based interface displayed to a user through a web browser.

14. The method of claim 1, wherein the application framework provides access to data stored in a collection of databases accessible in a network environment, the application framework comprising, a query specification for a requesting entity, the query specification comprising a plurality of logical fields for defining an abstract query; and
an access method for each logical field each of which defines a method for accessing a physical entity storing the data and a plurality of parameters to be passed to the method for accessing the physical entity.

15. The method of claim 14, wherein at least one physical entity comprises one of a relational database, XML database, or procedural database.

16. The method of claim 14, wherein the query specification further comprises a fee model and fee amount used for calculating a fee charged to a user for accessing data represented by a logical field.

17. The method of claim 14, wherein integrating a set of plug-ins with the application framework comprises obtaining at least one plug-in from the user.

18. A method for a user of an application framework to selectively incur fees for the use of an application framework accessible over a computer network, comprising the steps of:
obtaining one or more plug-in component constructed according to a set of specifications that define an interface to the application framework;
providing the plug-in components to a service provider hosting the application framework;
accessing the application framework and plug-in component using a computer connected to the network;
interacting with the application framework and plug-in component; and
incurring fees based on the activity that occurs.

19. The method of claim 18, wherein the plug-in component comprises at least one logic component configured to perform a computational task and has an associated fee model that specifies a fee amount corresponding to the computational task.

20. The method of claim 19, wherein incurring fees comprises a user selectively causing the application framework and plug-in component to perform computational tasks defined by the logic components.

21. The method of claim 18, wherein the user is presented an indication of a fee amount that will be incurred prior to performing a task or accessing or invoking a feature provided by the application framework or plug-in component.

22. The method of claim 18, wherein accessing the application framework comprises supplying the application framework with identifying information about the user.

23. The method of claim 22, wherein incurring fees comprises incurring fees based on the identity of the user.

24. A computer readable medium containing a program which, when executed, performs operations, comprising:
invoking an application framework on a host computer connected to a computer network;
integrating plug-in components provided to the application framework;
accepting connections requested by a user operating a remote computer connected to the computer network;
monitoring the activity of the user while the user is connected to the application framework and integrated plug-in components from the remote computer;
calculating fees owed to the provider of the application framework based on the activity of the user.

25. The computer readable medium of claim 24, wherein at least one plug-in component is provided to the application framework by the user.

26. A system connected to a network and accessible by a plurality of users over the network, comprising:
a host computer running an application framework configured to integrate a set of plug-in components;
one or more resources accessible by the application framework; and
an auditing component configured to:
monitor interactions between each of the plurality of users and the set of plug-in components; and
calculate a fee based upon each user's interactions with one or more of the set of plug-in components and application framework.

27. The system of claim 26, wherein at least one of the plug-in components is supplied to the application framework by one of the plurality of users.

28. The system of claim 27, wherein the interactions between each of the plurality of users and the set of plug-in components comprises users accessing or invoking logic components of the plug-ins or the features provided by the application framework.

29. The System of claim 26, wherein the set of resources comprises a query specification for a requesting entity, the query specification comprising a plurality of logical fields for defining an abstract query; and
an access method for each logical field each of which defines a method for accessing a physical entity storing the data and a plurality of parameters to be passed to the method for accessing the physical entity.

30. The system of claim 26, wherein the physical entity comprises one of a relational database, XML database or procedural database.
